(19) United States
(12) Patent Application Publication
(10) Pub. No.: US 2024/0420255 A1
(43) Pub. Date: Dec. 19, 2024

(54) SYSTEMS AND METHODS FOR USE IN ASSESSING TREATMENT TRIALS IN AGRICULTURAL FIELDS

(71) Applicant: CLIMATE LLC, Saint Louis, MO (US)

(72) Inventors: Jigyasa BHAGAT, South San Francisco, CA (US); Pei-Chen CHEN, South San Francisco, CA (US); Jake A. KING, Fenton, MO (US); Jacob P. MCDANIEL, O'Fallon, MO (US); Nicholas P. OCHS, Ellisville, MO (US); Jiahao SUN, San Francisco, CA (US)

(21) Appl. No.: 18/741,252

(22) Filed: Jun. 12, 2024

Related U.S. Application Data
(60) Provisional application No. 63/521,628, filed on Jun. 16, 2023.

(51) Int. Cl. G06Q 50/02; A01G 7/06; G06N 20/00

(52) U.S. Cl. CPC G06Q 50/02; A01G 7/06; G06N 20/00

(57) ABSTRACT

Systems and methods for use in assessing a treatment trial in an agricultural field. One example method includes, for each of multiple treatment trials in agricultural fields, generating, by a computing device, a post-harvest trial block, based on multiple data layers associated with the agricultural field, where the post-harvest trial block defines an area of the agricultural field associated with the treatment trial; clustering, by a computing device, a training set of the post-harvest trial block based on one or more geospatial features of the areas of the post-harvest trial blocks; training, by the computing device, a model to indicate a label for a target post-harvest trial block based on the one or more geospatial features of an area of the target post-harvest trial block; and storing the label in a memory.

### CROSS-REFERENCE TO RELATED APPLICATION

This application claims the benefit of, and priority to, U.S. Provisional Application No. 63/521,628, filed Jun. 16, 2023. The entire disclosure of the above application is incorporated herein by reference.

### FIELD

The present disclosure generally relates to systems and methods for use in assessing treatment trials in agricultural fields, based on data associated with the same.

### BACKGROUND

This section provides background information related to the present disclosure which is not necessarily prior art.

It is known for seeds to be grown in fields, for various purposes, including commercial purposes, whereby resulting plants, or parts thereof, are sold by the growers for business purposes and/or profit. Often, the growers may experiment with different variables (e.g., planting rates, seed products, application of pesticides, etc.) as part of management of the fields, for example, in certain fields. Experiments may be considered trials, and the results from the trials may then be used to support changes to the selected seeds, applications, or other management practices used in and/or on the fields, in future planting/growing plans by the growers.

### SUMMARY

This section provides a general summary of the disclosure, and is not a comprehensive disclosure of its full scope or all of its features.

Example embodiments of the present disclosure generally relate to computer-implemented methods for use in assessing treatment trials in agricultural fields. In one example embodiment, an example method includes, for each of multiple treatment trials in agricultural fields, generating, by a computing device, a post-harvest trial block, based on multiple data layers associated with the agricultural field, where the post-harvest trial block defines an area of the agricultural field associated with the treatment trial; clustering, by a computing device, a training set of the post-harvest trial block based on one or more geospatial features of the areas of the post-harvest trial blocks; training, by the computing device, a model to indicate a label for a target post-harvest trial block based on the one or more geospatial features of an area of the target post-harvest trial block; and storing the label in a memory.

Example embodiments of the present disclosure also generally relate to systems for use in assessing treatments trials in agricultural fields. In one example embodiment, a system includes an agricultural computer system, which is configured, by executable instructions, to perform one or more of the operations recited in the above example method(s) and/or system(s). Example embodiments of the present disclosure also generally relate to non-transitory computer-readable storage media comprising executable instructions for assessing treatment trials in agricultural fields, which when executed by at least one processor, cause at least one processor to perform one or more of the operations recited in the above example method(s) and/or system(s).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example embodiment of a system for assessing treatment trials in agricultural fields (e.g., in one or more target fields, etc.);

FIG. 2 illustrates example data layers that may be used, in connection with the system of FIG. 1, to compile one or more post-planting trial blocks indicative of the planting of an agricultural field;

FIG. 3 illustrates example data layers that may be used, in connection with the system of FIG. 1 and the post-planting trial block of FIG. 2, to compile a post-harvest trial block indicative of harvest of an agricultural field;

FIG. 4 illustrates different post-harvest trial blocks, each having a different assessed label, which may be used in connection with the system of FIG. 1;

FIG. 5 illustrates an example method of assessing treatment trials in agricultural fields, and where the method may be employed in connection with the system of FIG. 1;

FIGS. 6A-6B illustrates example logical organization of sets of instructions in main memory of a computing device when an example application is loaded for execution; and

FIG. 7 is a block diagram that illustrates an example computer system upon which embodiments of the system of FIG. 1 and/or the method of FIG. 5 may be implemented.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Experiments, also referred to as trials, may be used by growers or others to provide support for changes in seeds selected for planting in fields, or, more generally, changes in treatments of fields and/or crops included in the fields, etc. In some examples, the trials may be defined in strips, where, for example, alternating strips are provided to test a decision, while also accounting for variations in the field (e.g., control-test-control-test, etc.), or the trials may be defined in other spatial configurations (other than strips), whereby a particular shape of the experiment is not required, etc. while still accounting for the variations, etc. The number of types of trials vary, by grower, by field, etc., whereby factors other than the specific trial (e.g., seed products, applications, etc.) may impact the outcome of the trial. As such, different trials are associated with different quality, whereby one trial may be more indicative of improvement over another trial. Assessing the quality of the different trials is difficult, subjective, and/or associated with significant resources. As recognized by the inventors hereof, a more objective, efficient manner of assessing trials is desired and/or needed.

Uniquely, the systems and methods herein provide for assessing trials in agricultural fields based on data associated with the planting and harvesting of the agricultural field in which the trials are imposed.

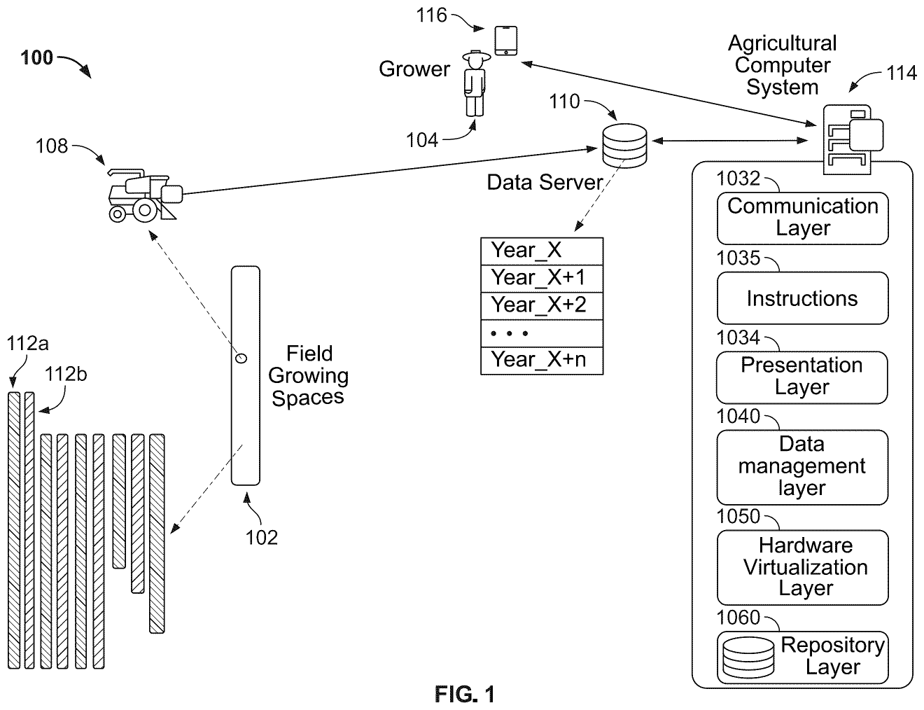

FIG. 1 illustrates an example system 100 in which one or more aspect(s) of the present disclosure may be implemented. Although the system 100 is presented in one arrangement, other embodiments may include the parts of the system 100 (or other parts) arranged otherwise depending on, for example, relationships between users (e.g., growers, etc.) in the system 100, agricultural devices used in the system 100 and numbers and/or arrangements of fields, data flows, types of crops, types and/or locations of fields, numbers and/or types of trials included in fields, planting and/or harvest activities in the fields, privacy and/or data requirements, etc.

The system 100 generally includes various growing spaces (e.g., greenhouses, shade houses, nurseries, plots, fields, etc.), which are represented by a field 102. The field 102 may include one or more commercial fields, for which seeds are purchased by a grower, grown in the fields, and then the crops are harvested and potentially commercialized. The field 102 is often owned by a farmer and/or grower entity in the business of growing, harvesting, and selling crops. In connection therewith, the farmer/grower may alter the planted seeds, or the conditions of the field 102, as the seeds grow into plants (e.g., through treatments, irrigation, etc.), and then harvest the crops with a variety of different farm equipment (e.g., combines, pickers, etc.).

It should be appreciated that the seeds may be planted in the field(s) in a number of different manners. In one example, a field may be subjected to split planting, in which multiple different seeds are planted in the same field. In the illustrated system 100, for example, the field 102 includes nine distinct regions, which define a number of rows (e.g., five rows, nine rows, fifteen rows, more or fewer rows, etc.), which alternately include two different types of seeds in regions 112a, 112b, as indicated by the different hatching. The seeds are distributed in the field 102, such that every other region includes one type of seed (as indicated by the hatching) (e.g., a specific hybrid, variety, etc.).

In this manner, the seeds are planted “side-by-side” in regions 112a, 112b (broadly, in a split-planting configuration) and subject to substantially similar conditions (e.g., relative to different fields in the same or different regions, etc.), whereby the data from the field 102 is generally indicative (with management practices remaining equal) of the relative performance between the two seeds in the regions 112a, 112b.

It should be appreciated that the number of rows/sets, types, and/or varieties of seeds, along with the distribution of the same or different seeds, and the planting times of the seeds, may vary in other field growing spaces, depending, for example, of the growing objectives of the growers, soil conditions, harvesting conditions (e.g., width of a combine, etc.), market demand, etc. What's more, while different seeds are being considered in the illustrated “trial” in the example embodiment of FIG. 1, the trial may include other variations between the regions, such as treatment applications (e.g., herbicide, pesticide, fertilizer, fungicide, or other treatments, etc.), planting/seeding rates, irrigation, other management practices or input, or generally other defined differences between the regions 112a, 112b, broadly, treatments, etc., to assess the different treatments between the regions 112a, 112b. As such, a treatment trial may therefore include different seeds, but may alternatively include various other differences (or combinations of differences) to be tested in the field 102.

In addition to the field 102 in FIG. 1, the system 100 includes one or more agricultural devices (as represented by the agricultural device 108), a data server 110, an agricultural computer system 114, and a field manager computing device 116 (associated with user 104), each of which is coupled to (and is in communication with) one or more network(s). The network(s) is/are indicated generally by arrowed lines in FIG. 1, and may each include, without limitation, one or more of a local area networks (LANs), wide area network (WANs) (e.g., the Internet, etc.), mobile/cellular networks, virtual networks, and/or another suitable public and/or private networks capable of supporting communication among parts of the system 100 illustrated in FIG. 1, or any combination thereof.

In this example embodiment, the agricultural device 108 may include a planter, a sprayer, a harvester (e.g., combine, picker, etc.), whereby the agricultural device 108 is configured to aid in planting, spraying and/or harvesting of the crops from the field 102, for example.

The agricultural device 108 may be automated, or reliant, at least in part, on a human operator, etc. The agricultural device 108, in general, is configured to compile data specific to the seed being planted, the substances being sprayed, and/or the plant(s) being harvested, and also the location of the same, etc. The data may include, without limitation, seed identifiers and types, planting dates, planting/seeding rates, chemical identifiers and types, yields, weights, moisture content, volume, flow, or other suitable data, etc., associated with an operation of the agricultural device 108. Further, in this example, the agricultural device 108 is configured to track its locations at given times and/or operations, as expressed in latitude/longitude or otherwise, and to correlate the locations to other data gathered/compiled. In this manner, the data may include a map of seeds planted in a field, by location, and also subsequently, a map of crops harvested from the fields, by location.

The agricultural device 108 is further configured to transmit the gathered data to the data server 110. That said, the agricultural device 108 may be configured to transmit data to one or more different data servers, which may be included in other embodiments, with the different data servers being specific to certain growing spaces, geographic regions, growers, etc.

The data server 110, in turn, is configured to store the received data in one or more data structures. In general, in this example embodiment, the data server 110 is configured to store data by year (e.g., Year_X, Year_X+1, etc.), which corresponds to the different growing years (e.g., 2020, 2021, 2022, etc.). Then, for each year, the data structure includes the data for each field (e.g., the field 102, etc.), etc. For example, for each field designation or identifier, the data structure may include an identifier for each seed planted in the field in the given year, the location of the seed, the brands for seeds, relative maturity, types of insect protection traits, seed treatment, positions/rates of seeds in fields, location definitions of fields, acreage of fields, yields, grain moisture (e.g., based on location and seed products, etc.), etc. The data may also include operating paths or routes of the agricultural device 108 in the field 102 (e.g., traversals, etc.), and associated or neighboring fields, etc. The data may further include soil conditions, field elevations, precipitation amounts, irrigation amounts, or any other data indicative of the growing conditions for the seeds/plants in the field, etc. It should be appreciated that any suitable and/or desired data may be collected with regard to the plots, fields, etc., in the different growing spaces and/or the seeds planted therein and included in the above data structure.

The data included in the data structure(s) of the data server 110 may be augmented with additional information about seeds from one or more other sources, including, for example, a category of the seeds (e.g., relative maturity, etc.), product name, source name, or additional data about the agricultural device 108, the field 102, etc.

Given the above, the agricultural computer system 114 is programmed, or configured, to access the data related to the field 102 from the data server 110, and to assess the quality of any trials, which were performed in the field 102.

In particular, the agricultural computer system 114 is configured to access data from the data server 110 for the field 102. The data includes, generally, planting data and harvest data for the field, as well as any other data related to the treatment applied to the field 102, as desired or required.

For planting, the agricultural computer system 114 is configured to access multiple different data layers associated with and/or indicative of the field 102, which may include, for example, a headlands layer, an emergent seed layer, a planting traversals layer, and a split planting layer. The headlands layer includes a map of the field 102, with the headlands (by location) indicated as a band along the perimeter of the field 102, which is associated with turns, etc., of the agricultural device 108, as it plants the seeds in the field 102. The headland layer may also define objects within the field 102, such as, for example, a utility tower and a band of land around the utility tower. In general, the headland layer includes locations at which the agricultural device 108 is either stationary or moving in a manner that may impact the uniformity of planting, sensing, or other operation of the agricultural device 108 (or locations that in generally may impact movement of the agricultural device 108).

The emergent seed layer indicates that seeds have emerged in the field 102, for example, where different seeds were planted in the field 102 at a location, i.e., original and replant, etc. The emergent seed layer indicates a last planted seed in the locations of the field 102. The planting traversal layer indicates the route, path, and/or manner in which the agricultural device 108 moved in the field 102 during planting. That is, the planting traversals layer includes data related to or indicative of the traversals in the field 102, the direction in which the planter was moving while planting the seed, speed, heading angle, pass identifier, time/date, etc. In addition, finally, the split planting layer is a map indicative of the presence of different seeds (or more generally, a different treatment), consistent with the trial, planted (or applied) in the field 102 by an identifier of the seed (or treatment) and location.

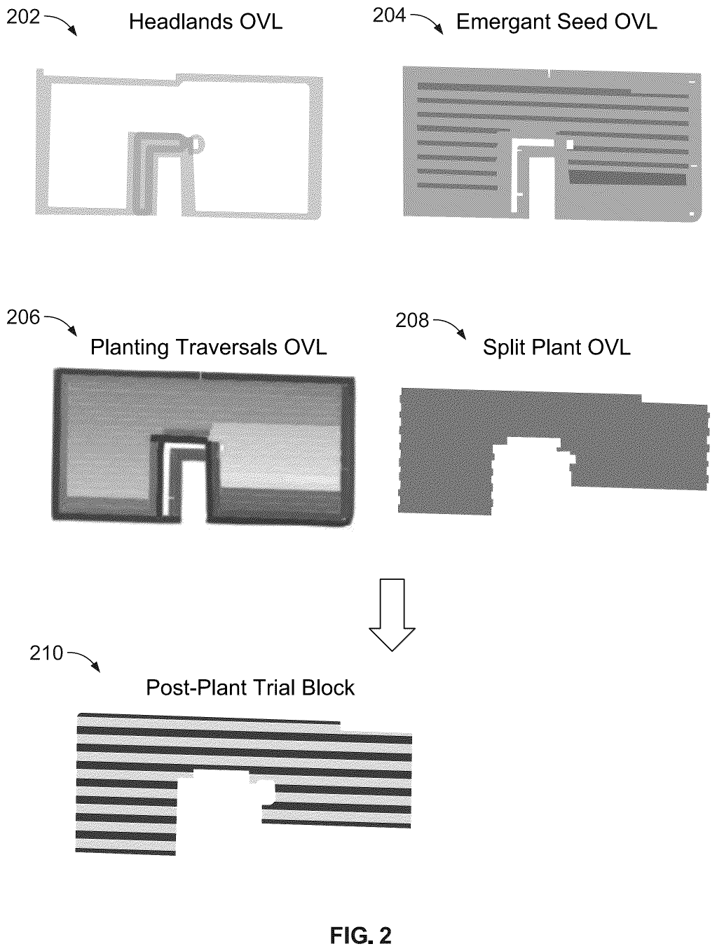

FIG. 2 illustrates examples of the above four data layers for the field 102, including an example headland data layer 202, an example emergent seed layer 204, an example planting traversals layer 206 and an example split planting layer 208. As shown, the headlands data layer 202, for example, indicates a band around the outer perimeter of the specific illustrated field, as well as the other associated areas lacking specific uniformity, etc., and the split planting data layer 208 indicates a coverage of the split planting trial. It should be appreciated that when the treatment trial is for something other than different seeds, the data layers accessed by the agricultural computer system 114 may be different. For example, the emergent seed layer 204 may be omitted when the treatment is a herbicide treatment, and one or more different layers (e.g., related to weather, etc.) may be included to account therefore (e.g., a herbicide application layer, etc.), etc.

Once accessed, the agricultural computer system 114 is configured to generate a post-planting trial block 210 for the field 102, as a specific combination of the data layers 202-208, based on one or more rules. For example, the rules may limit planting time, whereby the trial block 210 is compiled from data within an interval, such as, for example, one day, three days, etc. If the field 102 is planted over more than three days, for example, the agricultural computer system 114 is configured to split the field 102 into more than one trial block, or potentially, to discard some or all of the associated data, or the trial. The agricultural computer system 114 may be further configured, by one or more rules, to limit the trial block 210 based on the treatment, such as, for example, only two different seeds, only one chemical application, etc.

The agricultural computer system 114 may further be configured, by one or more rules, to discard the trial block 210 based on the coverage or acreage of the different treatments. For example, in a seed comparison trial, the agricultural computer system 114 may be configured to discard the trial block when either seed1 or seed2 of the trial covers less than one acre, two acres, or more or less. In other embodiments, the one or more rules may require growers to plant a specific pair of seed products. The agricultural computer system 114 may then be configured to validate the trials by checking whether the trials include ones of the specific pairs of seed products, whereby data for trials not consistent with the specific pairs is discarded or omitted from further analysis.

It should be appreciated that various rules may be imposed by the agricultural computer system 114 to ensure the trials align with one or more objectives and/or that the data associated with the trials is sufficient to be used to assess the treatment(s) to which the trials is/are directed.

Subject to the above, the agricultural computer system 114 is configured to start from the planting data, to perform one or more differences, intersections, etc., of the data layers above to define the post-planting trial block (e.g., the post-planting trial block 210 of FIG. 2, etc.). In particular, for example, to initially create the post-planting trial block 210, the agricultural computer system 114 is configured to identify the field 102 as being split-planted by having the split planting data layer 208 indicative of the different seeds planted therein. The agricultural computer system 114 is then configured to remove locations indicated in the headlands data layer 202, from the split planting data, and also to then stack the emerged seed products from the emergent seed data layer 204 into the remaining split planting data, whereby the data is aligned based on location. It should be appreciated that the agricultural computer system 114 may be further configured to buffer the resulting data to remove one or more small areas (as defined by the relative size, or threshold, etc.) and/or to simplify the boundary.

As such, in this example, the combination of the various data layers (e.g., headland data layer 202, emergent seed layer 204, planting traversals layer 206, and split planting layer 208) defines the example post-planting trial block 210, which is illustrated in FIG. 2.

The agricultural computer system 114 is configured to store the post-planting trial block 210 in memory, such as, for example, in one or more of the data servers, etc.

Further, as it relates to harvest, the agricultural computer system 114 is configured to access multiple data layers for the field 102, which include, for example, a harvest traversal layer and a confounded harvest layer. The harvest traversal layer indicates the path of the agricultural device 108, or combine, for example, in harvesting the field 102. The harvest traversal layer indicates the location of the agricultural device 108, its direction of travel and/or heading angle, speed, pass identifier, time/date, etc. The confounded harvest layer indicates a contamination and/or commingling of the different seeds of the trial. For example, depending on the position/location of the agricultural device 108 during harvest, one or two rows of seed1 may be harvested along with fifteen or more rows of seed2, whereby the confounded harvest is defined. Alternatively, for an application trial, the confounded harvest layer may be defined by a percent mix of application (sprayed) and no_application (unsprayed). For example, if the field 102 is being harvested with a twelve-row combine and three rows were sprayed and nine rows were unsprayed, it would be 25% contaminated with unsprayed, as indicated in the confounded harvest data layer. It should be understood that drift may be considered, whereby the agricultural computer system 114 is configured to buffer the data to remove areas where physical drift may have taken place at the time of application. It should also be appreciated that the confounded harvest data layer may also indicated contamination related to seed treatment, fertility, and tillage, or any other trial contemplated herein, etc.

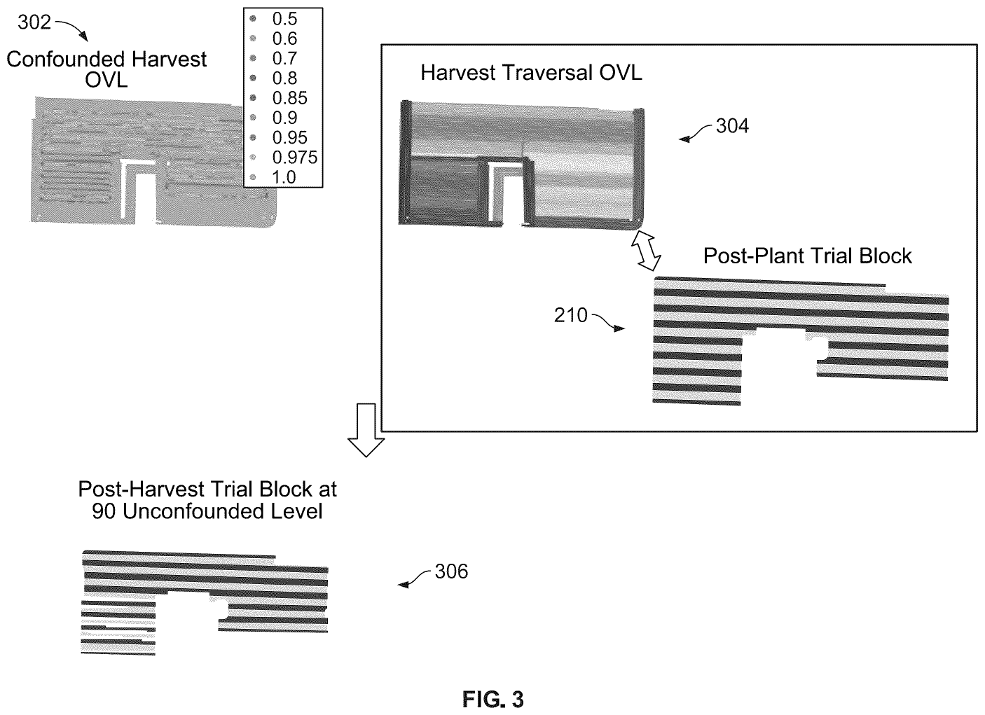

FIG. 3 illustrates, for an example harvest of the field 102, an example harvest traversal layer 304 and an example confounded harvest layer 302, which are associated with the same field 102 as the data layers illustrated in FIG. 2.

In connection therewith, the agricultural computer system 114 is configured to combine the post-planting trial block (e.g., the posting-planting trial block 210, etc.) and the harvest traversal layer (e.g., the harvest traversal layer 304, etc.). For instance, the post-planting trial block 210 and the harvest traversal layer 304 are combined (e.g., intersected. etc.) based on location, whereby the harvest traversal layer 304 is effectively trimmed according to the data included in the post-planting trial block 210. In addition, the agricultural computer system 114 is configured further to impose one or more of the same or similar or different rules, as described above, on the harvest traversal layer 304, such as, for example, a limit on the number of days of harvest (e.g., split/discard when more than X days, etc.), a limit on coverage (e.g., at least one acre per seed, etc.), a limit on a number of different seeds (e.g., only two seeds, etc.), and a limit on matched hybrid pairings, etc.

Next, the agricultural computer system 114 is configured to identify the level of unconfounded harvest based on subtracting the confounded values from the confounded harvest layer 302 from one (e.g., 1-confounded value, per location; etc.), etc. The agricultural computer system 114 is configured to apply a grid to the field 102, which is defined by a number of cells having sizes of a number of pixels, for instance, in square meters (e.g., three by three block of pixel, or three meters by three meters, or more or less, etc.). The agricultural computer system 114 is then configured to retain the unconfounded data for the cell of the grid when the unconfounded data for that cell satisfies a threshold (e.g., 80%, 85%, 90%, 95%, or more or less, etc.). In one or more examples, when a part of the cell is below the threshold (and a part of the cell is above the threshold), the agricultural computer system 114 is configured to discard or drop the data for the entire cell (e.g., resulting in the gaps in example post-harvest trial block 306, etc.). That said, in other examples, the agricultural computer system 114 may be configured to drop only the parts of the unconfounded data for the cell, when those parts are below the threshold, whereby the unconfounded data for other parts of that cell is retained because the specific unconfounded data is above the threshold.

The agricultural computer system 114 is configured to then combine the unconfounded data, which is retained (or not dropped), with the traversal harvest layer 304 (subject to one or more rules), to define a bounded post-harvest trial block 306, wherein the combine harvest travel data layer is retained based on the unconfounded data layer. An example combination of the various data layers, as the example post-harvest trial block 306, is illustrated in FIG. 3. As shown, the confounded harvest layer 302 results in eliminating data from entire or partial cells in the grid (e.g., as defined by the unconfounded data, etc.), as shown between strips in the lower left segment of the post-harvest trial block 306.

The agricultural computer system 114 is configured to store the post-harvest trial block in memory, such as, for example, in one or more of the data servers, etc. For each of many fields (e.g., at least one hundred fields, hundreds of fields, or thousands of fields, or more, etc.), the agricultural computer system 114 is configured to generate the post-harvest trial blocks in a similar manner. In this manner, hundreds, thousands, or tens of thousands or more or less post-harvest trial blocks are generated. The agricultural computer system 114 is configured to similarly store the post-harvest trial blocks, as described above.

In addition to generating the specific post-harvest trial blocks, which may define which data is to be used in assessing the treatment trial, the agricultural computer system 114 is also configured to assess the quality of the post-harvest trial blocks.

In particular, in this example embodiment, the agricultural computer system 114 is configured to cluster the post-harvest trial blocks (for the many fields). Specifically, at the outset, a training set of the post-harvest trial blocks is created based on one or more manual reviews of the post-harvest trial blocks. The manual review may include a user, or multiple users, viewing the trial blocks at computer systems and then designating a label for each trial block, where the label is indicative of one of multiple groups. For example, the trial blocks may be labeled a worst, good, better, best, or may be labeled 0, 1, 2, 3, 4, 5, or may be labeled with other labels associated with or indicative of quality, etc. The labels may include two or more different groups, depending on, for example, differences among the trial blocks, a size of the training set, etc. In this example embodiment, the hundreds of trial blocks are labels consistent with three groups, worst, good, and best. What's more, the consensus label, or majority label, from the different users (if applicable), is appended to or associated with the trial block as stored in one or more of the data servers.

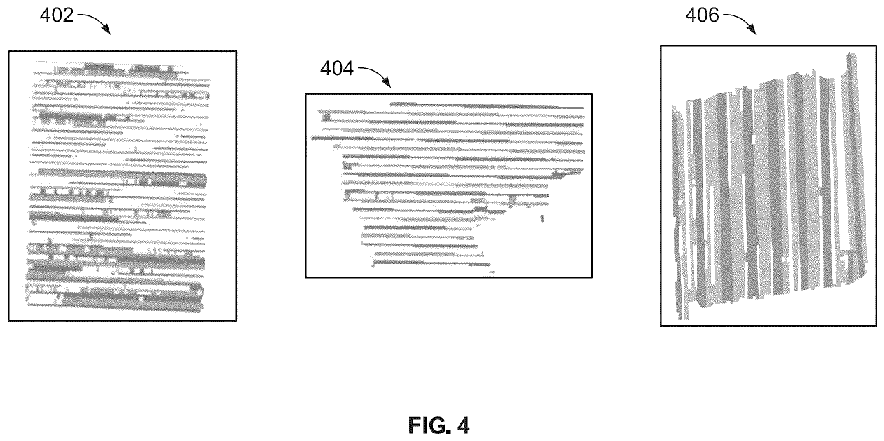

FIG. 4 illustrates three different post-harvest trial blocks, which represent a relatively poor post-harvest trial block 402, a good post-harvest trial block 404, and a best post-harvest trial block 406. It should be appreciated that quality of the post-harvest trial blocks may be different in other examples of the different groups of the trial blocks.

Once the training set is created, the agricultural computer system 114 is configured to assess geospatial features (including geographical features) of the post-harvest trial blocks, which are labeled.

For example, the agricultural computer system 114 may be configured to determine a ratio of one treatment in the post-harvest trial block to the other treatment in the post-harvest trial block (e.g., a ratio of area of seed1 to seed2, or a ratio of application to no_application, etc.), which may be an indication of balance, or more specifically, product area balance. In addition, the agricultural computer system 114 may be configured to assess the shape of the post-harvest trial block, as being close or not to a rectangular shape, for example, based on a bounding box (e.g., a percentage of a bounding box, for the post-harvest trial block, being filled by the post-harvest trial block; etc.), etc. In another example, the agricultural computer system 114 may be configured to determine a major area ratio, which includes the biggest area of a polygon fit in the post-harvest trial block (or fit around the trial block (e.g., bounding box, etc.)), relative to an area of the post-harvest trial block. In still another example, the agricultural computer system 114 may be configured to determine a percentage of a post-harvest trial block with contour planting passes.

It should be understood that any suitable expression of geospatial features of the post-harvest trial bocks may be employed, alone or in combination herein.

In this example embodiment, the agricultural computer system 114 is configured to cluster the training set of post-harvest trial blocks into different groups, based on the labels and/or the geospatial features. In one example, the cluster is based on the K-means clustering model. That said, different clustering models and/or techniques may be employed in other embodiments. In this manner, the clustering of the different post-harvest trial blocks provides for the association of the geospatial features of the post-harvest trial blocks with the applied labels.

It should be understood that in one or more embodiments, the agricultural computer system 114 may be configured to combine the training set of labeled post-harvest trial blocks with additional post-harvest trial blocks, which are not labeled. Once clustered, as explained more below, the agricultural computer system 114 may be configured to label the unlabeled post-harvest trials blocks with the labels of the post-harvest trial block clustered therewith. For example, where thirty unlabeled post-harvest trial blocks are clustered with more than two hundred post-harvest trials blocks labeled “good,” the agricultural computer system 114 is configured to label the thirty unlabeled post-harvest trials blocks “good.” As such, the agricultural computer system 114 may be configured to leverage the clustering and iterative processes to increase the training set to be used below.

The agricultural computer system 114 is configured to then train a supervised or semi-supervised learning model, based on the clusters of post-harvest trial blocks and/or the geospatial features of the clustered post-harvest trial blocks. The model then, after training, associates the labels with post-harvest trial blocks, generated as described above, based on the post-harvest trial blocks having the geographical or geospatial features. In this example embodiment, the particular model herein includes a support vector machine (SVM), or more specifically, a linear kernel SVM. Another example may include a self-training algorithm for the labeled data, which may include the Yarowsky algorithm.

Subject to the particular model, the agricultural computer system 114 is configured to initially train the algorithm (e.g., based on the available training set, etc.), and then, to label the unlabeled post-harvest trial blocks, and then to select a number of the applied labels (e.g., 250, 500, 1000, etc., labels based on highest confidence (e.g., based on a data instance farthest away from the decision hyperplane, etc.), etc.) to add to the training data set. The agricultural computer system 114 is configured to then repeat iteratively until the unlabeled post-harvest trial blocks are all labeled. Additionally, or alternatively, in one or more embodiments, the agricultural computer system 114 is configured to cluster the labeled and unlabeled post-harvest trial blocks, and label the unlabeled blocks consistent with the clusters to define a larger training set, for example, via the Yarowsky algorithm (e.g., based on an iterative cluster-and-label process, where labels are adopted into the training set per iteration based on confidence, etc.). The agricultural computer system 114 is then configured to use the labeled post-harvest trial blocks to train the final model, for example, the supervised SVM model.

It should be appreciated that a part of the training set may be used, by the agricultural computer system 114, to validate the trained model and to provide for additional modification and/or adjustments to the hyperparameters and/or parameters trained through the training set of post-harvest trial blocks. For example, for the SVM model, specifically, the agricultural computer system 114 may be configured to apply five-fold cross validation with grid search for hyper-parameter tuning and utilized feature importance for further feature selection. This validation of the model may be based, for example, on 20% of the training data set, which is segregated from the original training of the model above, etc.

Beyond validation, it should be appreciated that the agricultural computer system 114 may be configured to retrain the model at one or more intervals as additional, new, or different training data is available, in general or for specific types of treatments. In one specific example, the new labeled training data may be used with the prior trained version of the SVM model, whereby mislabeled data (by the prior trained version of the SVM model) is given more weight in training or updating a new version of the SVM model. Further, the model may be trained for treatment specific trials, where one model is associated with different seeds being planted, while the other is associated with different spray applications.

Thereafter, the agricultural computer system 114 is configured to, by the trained model, to append and store (in memory) quality labels to post-harvest trial blocks (as generated above) for further treatment trials in one or more fields, where the labels include, for example, worst, good, better, best.

In connection therewith, the agricultural computer system 114 is configured to discard certain post-harvest trial blocks and/or associated data for one or more assessments of the trial underlying the trial blocks. For example, where there are one thousand trials, and two hundred post-harvest trial blocks are labeled as worst, the agricultural computer system 114 may be configured to discard or drop the data associated with the two hundred post-harvest trial blocks and to proceed with assessment of the trial (e.g., split planting, treatment, etc.) based on the data associated with the remaining post-harvest trial blocks and data associated therewith.

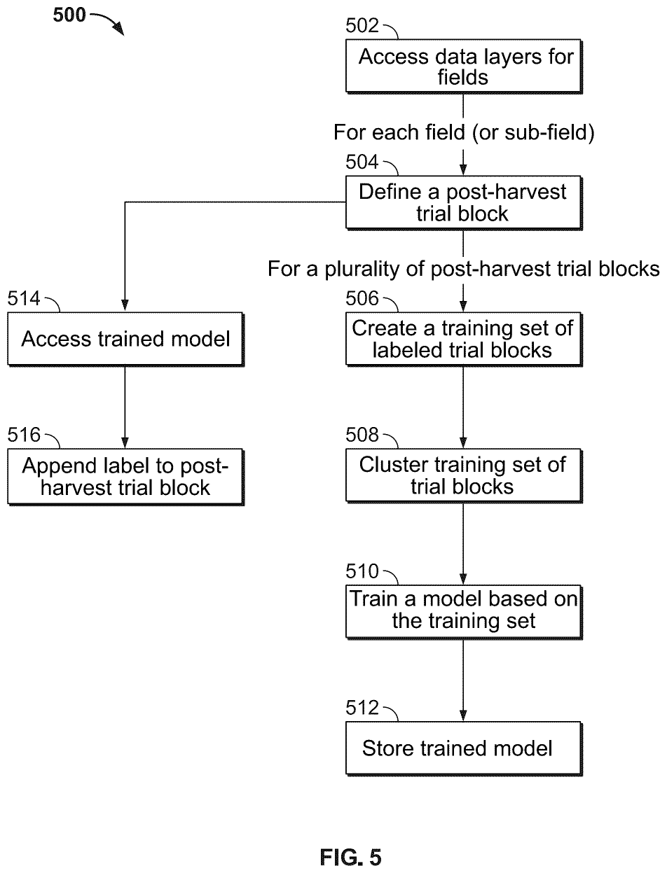

FIG. 5 illustrates an example method 500 for assessing treatment trials in various fields. The example method 500 is described herein in connection with the system 100, and may be implemented, in whole or in part, in the agricultural computer system 114 of the system 100. However, it should be appreciated that the method 500, or other methods described herein, are not limited to the system 100 or the agricultural computer system 114. And, conversely, the systems, data structures, and the computing devices described herein are not limited to the example method 500.

At the outset in method 500, the agricultural computer system 114 accesses data in the data server 110, at 502. For a given field, or sub-field, the data includes various different data layers related to one or more trials in the field, and/or to planting, harvest and/or management practices related to the field, and also, potentially, data indicative of the impact of the trial on the field. The data may include, without limitation, field identifiers, plot identifiers, soil data, planting dates/times, seed identifiers, split planting data (e.g., seeds identified per row/location, etc.), seeding rates, planter routing/path and associated location data, treatment identifiers and type (e.g., herbicide, fungicide, irrigation, etc.), split treatment data, treatment dates and locations, sprayer routing/path, weather data, harvest dates/times, harvest routing/path and associated location data (e.g., harvest pass or traversal data, etc.), etc., generally referred to herein as field data. It should be appreciated that any other suitable field data for use as described herein may be included in the data server 110 and accessed by the agricultural computer system 114.

Next in the method 500, the agricultural computer system 114 defines a post-harvest trial block for each field or sub-field (e.g., where there are multiple trials in one field, etc.), at 504. The post-harvest trial block generally defines an area of the trial, subject to rules, etc., which encompasses the trial while reducing the potential impact of operations in executing the trial (e.g., confoundedness, headlands, etc.).

In particular, in this example embodiment, the agricultural computer system 114 initially defines a post-planting trial block. To do so, in this embodiment, the agricultural computer system 114 combines various data layers, including a headlands data layer, a planting traversal data layer, an emergent seed data layer and a split planting data layer (for example, as explained above). The combination is subject to one or more rules, as also explained above. Specifically, the agricultural computer system 114 limits a trial block to planting being completed within an interval, such as, for example, one day, three days, etc. As such, if a field is planted over more than three days, for example, the agricultural computer system 114 either splits the field into more than one trial block, or depending on size or other features, discards the field, etc. The agricultural computer system 114 may also impose a rule to limit a trial block based on the treatment, such as, for example, only two different seeds, only one chemical application plus a control, etc. The agricultural computer system 114 may also impose a rule to discard the trial based on the coverage or acreage of the different treatments, whereby, for example, the agricultural computer system 114 discards a trial in which seed1 or seed2 covers less than one acre, two acres, or more or less, etc.

The agricultural computer system 114 stores the post-planting trial block in memory, such as, for example, in one or more of the data servers, etc.

Next, for a specific trial or field, the agricultural computer system 114 then combines the post-planting trial block and the harvest traversal layer. In connection therewith, the agricultural computer system 114 may impose one or more of the same or similar rules, as described above on the harvest traversal layer, such as, for example, a limit on a number of days of harvest (e.g., split/discard when more than X days, etc.), a limit on coverage (e.g., at least one acre per treatment, etc.), a limit on the number of different treatments (e.g., only two seeds, etc.), and a limit on matched hybrid pairings, etc.

The agricultural computer system 114 then identifies the level of unconfounded harvest based on a difference between the confounded values from the confounded harvest layer and one (e.g., 1-confounded value, per location), etc. Next, the agricultural computer system 114 applies a grid to the field, which is defined by a number of cells having suitable sizes, and the agricultural computer system 114 retains the unconfounded data for the cell when all of the unconfounded data included in that cell satisfies a threshold (or potentially, the data for the part of the cell for which the unconfounded data satisfied the threshold). The agricultural computer system 114 further combines the unconfounded data, which is retained or not dropped, with the traversal harvest layer (subject to the one or more rules, as explained above), to define the post-harvest trial block.

The agricultural computer system 114 stores the post-harvest trial block in memory, such as, for example, in one or more of the data servers, etc.

It should be appreciated that the post-harvest trial block may be compiled in another suitable manner to account for the data available and to limit impact of one or more extraneous factors unassociated with the specific trial.

As shown in FIG. 5, after the post-harvest trial blocks are defined, the agricultural computer system 114 enters a training stage for a model to label the different post-harvest trial blocks. In this example embodiment, a training set of the post-harvest trial blocks, from a plurality of post-harvest trial blocks, is created at 506. In particular, a number of the post-harvest trial blocks are labeled by manual review. The labeling may include, four or more or less labels, and the user may visually inspect the post-harvest trial block and append a label thereto, for example, one of poor, good, best, etc. Each of the number of post-harvest trial blocks may be subjected to manual review from multiple users, whereby the final label is a combination thereof (e.g., majority, or average, etc.) and is included in the training set along with the post-harvest trial block.

After the labels are appended, the agricultural computer system 114 clusters, at 508, the post-harvest trial blocks. The agricultural computer system 114 employs a K-mean clustering, in this example, where each of the post-harvest trials block is an observation, in which different geographical or geospatial features of the same are the dimensional vector for the observation, to cluster the post-harvest trial blocks into a number of clusters equal to the number of labels (e.g., three, etc.). In this example embodiment, the dimensions of the post-harvest trial blocks include four specific geospatial features, without limitation, a ratio of one treatment in the trial block to the other treatment in the trial block (e.g., a ratio of area of seed1 to seed2, or a ratio of application to no_application, etc.); a shape of the trial block, as being close or not to a defined shape (e.g., a rectangle, etc.); a major area ratio, which includes the biggest area of a polygon fit in the trial block (or fit around the trial block (e.g., bounding box, etc.)), relative to an area of the trial block; and a percentage of a trial block with contour planting passes.

It should be appreciated that other geographical or geospatial features, or combinations of geographical or geospatial features, may be employed in other clustering steps, whereby the cluster is enhanced and/or improved.

After clustering the post-harvest trial blocks, the agricultural computer system 114 trains, at 510, a model based on the training set and clustering. The agricultural computer system 114 may employ one or three different training implementations, as explained below.

Initially, according to a first implementation, the agricultural computer system 114 performs a preliminary feature selection based on exploratory data analysis (EDA) insights for the labeled post-harvest trial blocks included in the training set in order to select features indicative of and/or correlated with the labels applied to the post-harvest trial blocks. The features, in general, are the geographical or geospatial features of the trial blocks, as included, for example, in Table 1.

TABLE 1

| | |
|---|---|
| headland_to_planting_ratio | headlands to planting area ratio |
| active_planting_ac | planting area after headlands removal |
| shape_ratio | Area of the result trial block |
| | relative to minimum rotated |
| | rectangle at one confounded level |
| pt_contour | Percent of post-harvest trial block that |
| | has contour metrics over a threshold |
| weighted_contour_metric | weighted average of the actual contour |
| | metric |
| long_passes_pct | Percent of pass length in a post-harvest |
| | trial block is at least 5% of length of |
| | original harvest traversal passes. |
| n_unique_pass | Number of planting passes in |
| | post-harvest trial block |
| n_metric | Number of planting passes in |
| | post-harvest trial block contain |
| | the contour metrics |
| one_result_area_m2 | Area of result trial block at one |
| | unconfounded level |
| result_to_harvest_ratio | area ratio of result trial block to post |
| | harvest trial block at one unconfounded |
| | level |
| balance_score | Balance score of first to second seed |
| | product in a result trial block at |
| | one unconfounded level |
| n_patches (n_polygons) series | Number of single polygons |
| | exploded from multiple |
| | polygons of a result trial |
| | block at one unconfounded level |
| n_clean_patches series | Number of cleaned single polygons |
| | (area >20 m\hat{ }2) exploded from multiple |
| | polygons of a result trial block |
| | at one unconfounded level |
| major_area_patch series | Area of largest single polygon area |
| | relative to area of the entire result |
| | trial block at one unconfounded level |
| n_vertices series | Number of vertices (angles) of a result |
| | trial block at one unconfounded level |

Next, the agricultural computer system 114 performs a synthetic minority over sampling technique, or SMOTE, in order to address imbalances, etc. For example, in example data, there may be 825 positive samples and 268 negative samples, which is considered a class imbalance. SMOTE is a data sampling procedure, which is used herein for up-sampling and down-sampling, depending on the class. To up-sample for the minority class, SMOTE synthesizes new cases. To do this, a data point is randomly selected from the minority class and its K-nearest neighbors (KNNs) are determined. The new synthetic data point is a random combination of the predictors of the randomly selected data point and its neighbors. Conversely, SMOTE may be used to down-sample cases from the majority class via random sampling. Subsequently, the agricultural computer system 114 applies linear kernel and Radial Basis Function kernel SVM (Support Vector Machine) Models, and then performs parameter tuning through cross-validation with grid search, thereby completing the training of the SVM model.

In a second implementation, the agricultural computer system 114 employs an iterative approach to build the classifier model. Initially, the agricultural computer system 114 trains the classifier (e.g., the SVM model, etc.) on the labeled post-harvest trial blocks based on a number of geographical or geospatial features of the blocks (e.g., five, ten, fifteen, etc.) whereby the hyperparameters are tuned through grid search validation. Then, the agricultural computer system 114 labels the unlabeled post-harvest trial blocks with the trained model. The agricultural computer system 114 then determines a confidence in the labels appended to the unlabeled post-harvest trial blocks, and adds a number of the newly labeled post-harvest trial blocks to the training set based on the confidence (e.g., a top 100, 200, 500, etc., trial block, a top 5%, etc.). The agricultural computer system 114 then iteratively repeats the above steps until all the unlabeled harvest trial blocks are labeled, or until a defined number of iteration is completed. At that, the model is trained.

In a third implementation, the agricultural computer system 114 compiles a set of post-harvest trial blocks, which includes both labeled and unlabeled trial blocks, and then, clusters, via the K-mean clustering, the set of post-harvest trial blocks. The clustering, in this example, includes four geographical or geospatial features, as defined above, and K is three (i.e., the number of different labels). For each cluster, then, the agricultural computer system 114 uses the self-training algorithm to generate labels for unlabeled trial blocks, based on the labeled points within that cluster. Finally, the agricultural computer system 114 then uses all of the labeled post-harvest trial blocks to train a final model (e.g., the SVM model, etc.).

After the model is trained, consistent with one or more of the above, the agricultural computer system 114 stores, at 512, the model in memory.

Subsequently, as additional trials are performed and data related to the same are collected, the agricultural computer system 114 accesses the data, as described above with reference to step 502, and then defines a post-harvest trial block for the trials, as described above with reference to step 504.

Then, as shown in FIG. 5, the agricultural computer system 114 accesses the trained model in memory, at 514, and then appends a label to the post-harvest trial block, at 516. The specific data associated with the labeled trial block may then be stored in memory and used immediately or at a later time, to assess the specific trials implemented in the fields.

With reference again to FIG. 1, the user 104 (e.g., a grower, a representative, another user, etc.) in the system 100 may own, operate or possess the field manager computing device 116 in a field location, or associated with a field location, such as the field 102 intended for agricultural activities or a management location for one or more agricultural fields. As generally described above, the field manager computing device 116 is programmed, or configured, to provide field data to the agricultural computer system 114 via one or more networks (as indicated by arrowed lines in FIG. 1) (e.g., for use in assessing a treatment trial in the field 102, etc.). The network(s) may each include, without limitation, one or more of a local area networks (LANs), wide area network (WANs) (e.g., the Internet, etc.), mobile/cellular networks, virtual networks, and/or another suitable public and/or private networks capable of supporting communication among parts of the system 100 illustrated in FIG. 1, or any combination thereof.

The various elements of FIG. 1 may also have direct (wired or wireless) communications links. For instance, the agricultural device 108 in the system 100, data server 110, agricultural computer system 114, and other elements of the system 100 may each comprise an interface compatible with the network(s) and programmed, or configured, to use standardized protocols for communication across the networks, such as TCP/IP, Bluetooth, CAN protocol and higher-layer protocols, such as HTTP, TLS, and the like.

Examples of field data may include, for example, (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), (k) soil, seed, crop phenology, pest and disease reporting, and predictions sources and databases, and (l) other data described herein, etc.

As described, data server 110 is communicatively coupled to the agricultural computer system 114 and is programmed, or configured, to send external data (e.g., data associated with the field 102, etc.) to the agricultural computer system 114 via the network(s) herein (e.g., for use assessing a treatment trial quality, etc.). The data server 110 may be owned or operated by the same legal person or entity as the agricultural computer system 114, or by a different person or entity, such as a government agency, non-governmental organization (NGO), and/or a private data service provider. Examples of external data include weather data, imagery data, soil data, seed data and seed selection data as described herein, data from the various fields herein, or statistical data relating to crops, among others. External data may include the same type of information as field data. In some embodiments, data server 110 may actually be incorporated within the system 114.

The system 100 also includes, as described above, agricultural device 108 configured to plant seeds in one or more fields and/or to harvest seeds from one or more fields (e.g., from the field 102, etc.). In some examples, the agricultural device 108 may have one or more remote sensors fixed thereon, where the sensor(s) are communicatively coupled, either directly or indirectly, via the agricultural device 108 to the agricultural computer system 114 and are programmed, or configured, to send sensor data to the agricultural computer system 114.

Additional examples of agricultural devices that may be included in the system 100 include tractors, combines, other harvesters, planters, trucks, fertilizer equipment, aerial vehicles including unmanned aerial vehicles, and any other item of physical machinery or hardware, typically mobile machinery, and which may be used in tasks associated with agriculture and/or related to operations described herein. In some embodiments, a single unit of the agricultural device 108 may comprise a plurality of sensors that are coupled locally in a network on the apparatus. Controller area network (CAN) is an example of such a network that can be installed in combines, harvesters, sprayers, and cultivators. In connection therewith, then, an application controller associated with the apparatus may be communicatively coupled to the agricultural computer system 114 via the network(s) and programmed, or configured, to receive one or more scripts that are used to control an operating parameter of the agricultural device 108 from the agricultural computer system 114. For instance, a controller area network (CAN) bus interface may be used to enable communications from the agricultural computer system 114 to the agricultural device 108, for example, such as how the CLIMATE FIELDVIEW DRIVE, available from Climate LLC, Saint Louis, Missouri, is used. Sensor data may consist of the same type of information as field data. In some embodiments, remote sensors may not be fixed to an agricultural apparatus but may be remotely located in the field and may communicate with one or more networks of the system 100.

Agricultural computer system 114 is programmed, or configured, to receive and/or to access field data from the field manager computing device 116, data server 110, and sensor data from one or more remote sensors in the system 100. Agricultural computer system 114 may be further configured to host, use or execute one or more computer programs, other software elements, digitally programmed logic, such as FPGAs or ASICs, or any combination thereof to perform translation and storage of data values, construction of digital models of one or more crops on one or more fields, generation of recommendations and notifications, and generation and sending of scripts, in the manner described further in other sections of this disclosure.

In an embodiment, the agricultural computer system 114 is programmed with or comprises a communication layer 1032, a presentation layer 1034, a data management layer 1040, a hardware/virtualization layer 1050, and a repository layer 1060. “Layer,” in this context, refers to any combination of electronic digital interface circuits, microcontrollers, firmware, such as drivers, and/or computer programs, or other software elements.

Communication layer 1032 may be programmed, or configured, to perform input/output interfacing functions including sending requests to the field manager computing device 116, data server 110, and remote sensor(s) for field data, external data, and sensor data respectively. Communication layer 1032 may be programmed, or configured, to send the received data to model and field data repository layer 1060 to be stored as field data (e.g., in computer system 114, etc.).

Presentation layer 1034 may be programmed, or configured, to generate a graphical user interface (GUI) to be displayed on the field manager computing device 116 (e.g., for use in interacting with agricultural computer system to review the assessment of one or more treatment trials, etc.) or other computers that are coupled to the system 114 through the network(s). The GUI may comprise controls for inputting data to be sent to the agricultural computer system 114, generating requests for models and/or assessments, and/or displaying assessments, notifications, models, and other field data.

Data management layer 1040 may be programmed, or configured, to manage read operations and write operations involving the repository layer 1060 and other functional elements of the system, including queries and result sets communicated between the functional elements of the system and the repository. Examples of the data management layer 1040 include JDBC, SQL server interface code, and/or HADOOP interface code, among others. Repository layer 1060 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data is not provided directly to the agricultural computer system 114 via one or more agricultural devices that interact with the agricultural computer system 114, the user 104 may be prompted via one or more user interfaces on the device 116 (served by the agricultural computer system 114) to input such information for use in effecting the selections herein. In an example embodiment, the user 104 may specify identification data by accessing a map on the device 116 (served by the agricultural computer system 114) and selecting specific CLUs that have been graphically shown on the map. In an alternative embodiment, the user 104 may specify identification data by accessing a map on the device 116 (served by the agricultural computer system 114) and drawing boundaries of the field over the map. Such CLU selection, or map drawings, represent geographic identifiers. In alternative embodiments, the user 104 may specify identification data by accessing field identification data (provided as shape files or in a similar format) from the U.S. Department of Agriculture Farm Service Agency, or other source, via the device 116 and providing such field identification data to the agricultural computer system 114.

In an example embodiment, the agricultural computer system 114 is programmed to generate and cause displaying of a graphical user interface comprising a data manager for data input. After one or more trials have been assessed using the methods described above, the data manager may provide one or more graphical user interface widgets at the device 116 which when selected, may provide the assessments of the treatment trials. The data manager may include a timeline view, a spreadsheet view, a graphical view, and/or one or more editable programs.

In an embodiment, model and field data is stored in repository layer 1060. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implements the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

With reference again to FIG. 1, in an embodiment, instructions 1035 of the agricultural computer system 114 may comprise a set of one or more pages of main memory, such as RAM, in the agricultural computer system 114 into which executable instructions have been loaded and which when executed cause the agricultural computer system 114 to perform the functions or operations that are described herein. For example, the instructions 1035 may comprise a set of pages in RAM that contain instructions which, when executed, cause performing the assessment functions described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system that may vary depending on the memory architecture or processor architecture. In another embodiment, the instructions 1035 also may represent one or more files or projects of source code that are digitally stored in a mass storage device, such as non-volatile RAM or disk storage, in the agricultural computer system 114, or a separate repository system, which when compiled or interpreted cause generating executable instructions which when executed cause the agricultural computer system 114 to perform the functions or operations that are described herein. In other words, the drawing figure may represent the manner in which programmers or software developers organize and arrange source code for later compilation into an executable, or interpretation into bytecode or the equivalent, for execution by the agricultural computer system 114.

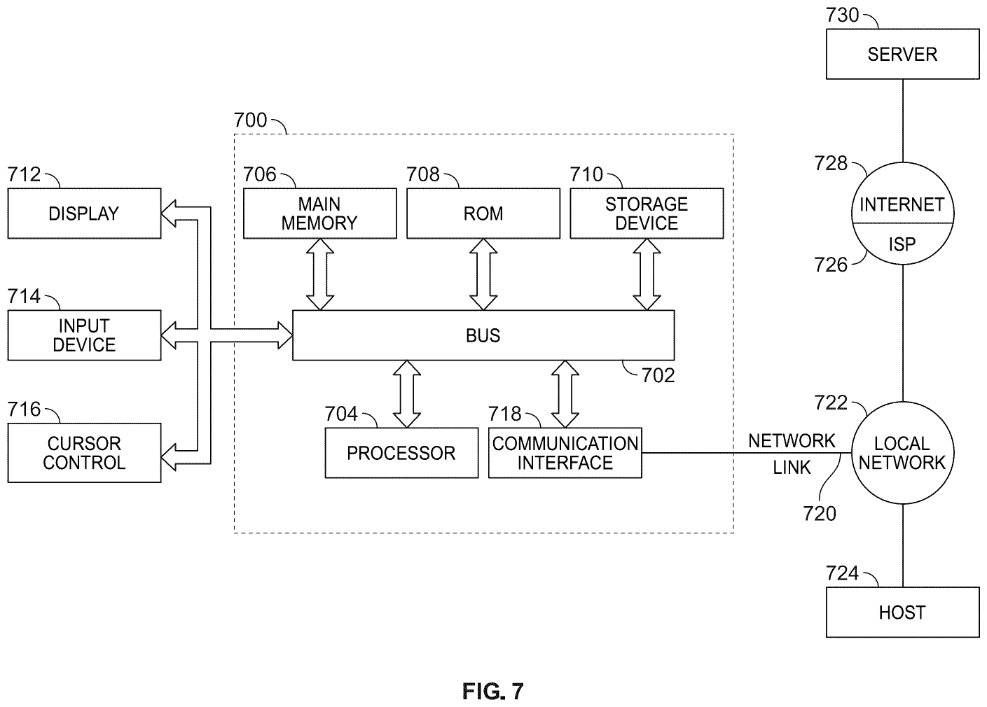

Hardware/virtualization layer 1050 comprises one or more central processing units (CPUs), memory controllers, and other devices, components, or elements of a computer system, such as volatile or non-volatile memory, non-volatile storage, such as disk, and I/O devices or interfaces as illustrated and described, for example, in connection with FIG. 7. The hardware/virtualization layer 1050 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different manager computing devices 116 associated with different users. Further, the system 114 and/or data server 110 may be implemented using two or more processors, cores, clusters, or instances of physical machines or virtual machines, configured in a discrete location or co-located with other elements in a datacenter, shared computing facility or cloud computing facility.

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for disclosures of this type.

In an embodiment, user 104 interacts with agricultural computer system 114 using field manager computing device 116 configured with an operating system and one or more application programs or apps; the field manager computing device 116 also may interoperate with the agricultural computer system 114 independently and automatically under program control or logical control and direct user interaction is not always required. Field manager computing device 116 broadly represents one or more of a smart phone, PDA, tablet computing device, laptop computer, desktop computer, workstation, or any other computing device capable of transmitting and receiving information and performing the functions described herein. Field manager computing device 116 may communicate via a network using a mobile application stored on field manager computing device 116, and in some embodiments, the field manager computing device 116 may be coupled using a cable or connector to one or more sensors and/or other apparatus in the system 100.

The mobile application associated with the field manager computing device 116 may provide client-side functionality, via the network to one or more mobile computing devices. In an example embodiment, field manager computing device 116 may access the mobile application via a web browser or a local client application or app. Field manager computing device 116 may transmit data to, and receive data from, one or more front-end servers, using web-based protocols, or formats, such as HTTP, XML and/or JSON, or app-specific protocols. In an example embodiment, the data may take the form of requests and user information input, such as field data, into the mobile computing device. In some embodiments, the mobile application interacts with location tracking hardware and software on the field manager computing device 116 which determines the location of field manager computing device 116 using standard tracking techniques, such as multilateration of radio signals, the global positioning system (GPS), WiFi positioning systems, or other methods of mobile positioning. In some cases, location data or other data associated with the field manager computing device 116, user 104, and/or user account(s) may be obtained by queries to an operating system of the field manager computing device 116 or by requesting an app on the field manager computing device 116 to obtain data from the operating system.

In an embodiment, in addition to other functionalities described herein, field manager computing device 116 sends field data to agricultural computer system 114 comprising or including, but not limited to, data values representing one or more of: a geographical location of the one or more fields, tillage information for the one or more fields, crops planted in the one or more fields, and soil data extracted from the one or more fields. Field manager computing device 116 may send field data in response to user input from user 104 specifying the data values for the one or more fields. Additionally, field manager computing device 116 may automatically send field data when one or more of the data values becomes available to field manager computing device 116. For example, the field manager computing device 116 may be communicatively coupled to a remote sensor in the system 100, and in response to an input received at the sensor, field manager computing device 116 may send field data to the agricultural computer system 114 representative of the input. Field data identified in this disclosure may be input and communicated using electronic digital data that is communicated between computing devices using parameterized URLs over HTTP, or another suitable communication or messaging protocol. In that sense, in some aspects of the present disclosure, the field data provided by the field manager computing device 116 may also be stored as external data (e.g., where the field data is collected as part of harvesting crops from the field 102, etc.), for example, in data server 110.

A commercial example of the mobile application is CLIMATE FIELDVIEW, commercially available from Climate LLC, Saint Louis, Missouri. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

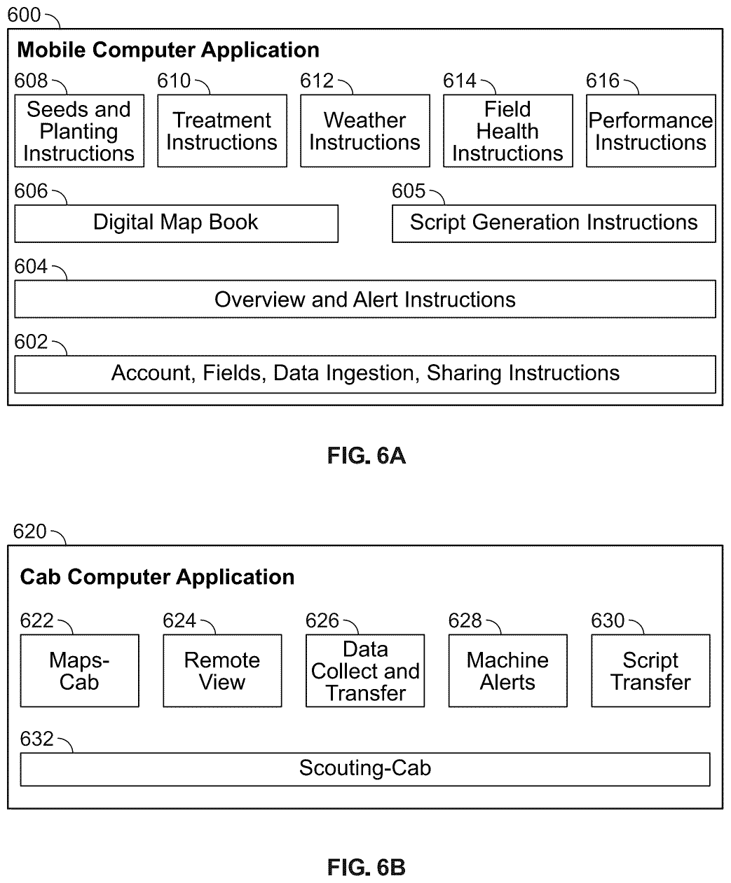

FIGS. 6A-6B illustrate two views of an example logical organization of sets of instructions in main memory when an example mobile application is loaded for execution. Each named element represents a region of one or more pages of RAM or other main memory, or one or more blocks of disk storage or other non-volatile storage, and the programmed instructions within those regions. In one embodiment, in FIG. 6A, a mobile computer application 600 comprises account, fields, data ingestion, sharing instructions 602, overview and alert instructions 604, digital map book instructions 606, seeds and planting instructions 608, treatment instructions 610, weather instructions 612, field health instructions 614, and performance instructions 616.

In one embodiment, a mobile computer application 600 comprises account, fields, data ingestion, sharing instructions 602 which are programmed to receive, translate, and ingest field data from third party systems via manual upload, or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 600 comprises a data inbox. In response to receiving a selection of the data inbox, the mobile computer application 600 may display a graphical user interface for manually uploading data files and importing uploaded files to a data manager.

In one embodiment, digital map book instructions 606 comprise field map data layers stored in device memory and are programmed with data visualization tools and geospatial field notes. This provides growers with convenient information close at hand for reference, logging and visual insights into field performance. In one embodiment, overview and alert instructions 604 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 608 are programmed to provide tools for seed selection, hybrid placement, and script creation, including variable rate (VR) script creation, based upon scientific models and empirical data. This enables growers to maximize yield or return on investment through optimized seed purchase, placement and population.

In one embodiment, script generation instructions 605 are programmed to provide an interface for generating scripts, including planting scripts, application scripts, variable rate (VR) fertility scripts. The interface enables growers to create scripts for field implements, such as applications, planting, and irrigation. For example, a planting script interface may comprise tools for identifying a type of seed for planting. Upon receiving a selection of the seed type, mobile computer application 600 may display one or more fields broken into management zones, such as the field map data layers created as part of digital map book instructions 606. In one embodiment, the management zones comprise soil zones along with a panel identifying each soil zone and a soil name, texture, drainage for each zone, or other field data. Mobile computer application 600 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 600 may make the script available for download in a format readable by an application controller, such as an archived or compressed format. Additionally, and/or alternatively, a script may be sent directly to a cab computer (e.g., associated with agricultural device 108, etc.) from mobile computer application 600 and/or uploaded to one or more data servers and stored for further use.

In one embodiment, treatment instructions 610 are programmed to provide tools to inform treatment decisions. This enables growers to assess and select different treatments before, during or after the season. Example programmed functions include displaying images to enable drawing of trials blocks and/or images generated from planting or harvest data, as indicated with the various layers above.

In one embodiment, weather instructions 612 are programmed to provide field-specific recent weather data and forecasted weather information. This enables growers to save time and have an efficient integrated display with respect to daily operational decisions.

In one embodiment, field health instructions 614 are programmed to provide timely remote sensing images highlighting in-season crop variation and potential concerns. Example programmed functions include cloud checking, to identify possible clouds or cloud shadows; determining nitrogen indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 616 are programmed to provide reports, analysis, and insight tools using on-farm data for evaluation, trial assessments as described herein, insights and decisions. This enables the grower to seek improved outcomes for the next year through fact-based conclusions about why return on investment was at prior levels, and insight into yield-limiting factors. The performance instructions 616 may be programmed to communicate via the network(s) to back-end analytics programs executed at agricultural computer system 114 and/or data server 110 and configured to analyze metrics, such as yield, yield differential, hybrid, population, or elevation, among others. Programmed reports and analysis may include yield variability analysis, treatment assessment, and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of a cab computer (e.g., associated with agricultural device 108, etc.). For example, referring now to FIG. 6B, in one embodiment a cab computer application 620 (e.g., as accessible in the agricultural device 108, etc.) may comprise maps-cab instructions 622, remote view instructions 624, data collect and transfer instructions 626, machine alerts instructions 628, script transfer instructions 630, and scouting-cab instructions 632. The code base for the instructions of FIG. 6B may be the same as for FIG. 6A and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 622 may be programmed to provide map views of fields, farms or regions that are useful in directing machine operation. The remote view instructions 624 may be programmed to turn on, manage, and provide views of machine activity in real-time or near real-time to other computing devices connected to the computer system 114 via wireless networks, wired connectors or adapters, and the like. The data collect and transfer instructions 626 may be programmed to turn on, manage, and provide transfer of data collected at sensors and controllers to the computer system 114 via wireless networks, wired connectors or adapters, and the like (e.g., via network(s) in the system 100, etc.). The machine alerts instructions 628 may be programmed to detect issues with operations of the machine or tools that are associated with the cab and generate operator alerts. The script transfer instructions 630 may be configured to transfer in scripts of instructions that are configured to direct machine operations or the collection of data. The scouting-cab instructions 632 may be programmed to display location-based alerts and information received from the computer system 114 based on the location of the field manager computing device 116, agricultural device 108, or sensors in the field 102 and ingest, manage, and provide transfer of location-based scouting observations to the computer system 114 based on the location of the agricultural device 108 or sensors in the field 102, etc.

In an embodiment, data server 110 stores external data, including soil data representing soil composition for the one or more fields and weather data representing temperature and precipitation on the one or more fields. The weather data may include past and present weather data as well as forecasts for future weather data. In an embodiment, data server 110 comprises a plurality of servers hosted by different entities. For example, a first server may contain planting data while a second server may include harvest data. Additionally, soil composition data may be stored in multiple servers. Further, in some embodiments, the data server 110, again, may include data associated with the field 102 with regard to available seeds for use in comparisons, etc.

In an embodiment, remote sensors in the system 100 may comprise one or more sensors that are programmed, or configured, to produce one or more observations. Remote sensors may be aerial sensors, such as satellites, vehicle sensors, planting equipment sensors, tillage sensors, fertilizer or insecticide application sensors, harvester sensors, and any other implement capable of receiving data from the one or more fields. In an embodiment, agricultural device 108 may include an application controller programmed, or configured, to receive instructions from agricultural computer system 114. The application controller may also be programmed, or configured, to control an operating parameter of the agricultural device 108. Other embodiments may use any combination of sensors and controllers, of which the following are merely selected examples.

The system 100 may obtain or ingest data under user 104 control, on a mass basis from a large number of growers who have contributed data to a shared database system. This form of obtaining data may be termed “manual data ingest” as one or more user-controlled computer operations are requested, or triggered, to obtain data for use by the computer system 114. As an example, the CLIMATE FIELDVIEW application, commercially available from Climate LLC, Saint Louis, Missouri, may be operated to export data to computer system 114 for storing in the repository layer 1060.

For example, seed monitor systems can both control planter apparatus components and obtain planting data, including signals from seed sensors via a signal harness that comprises a CAN backbone and point-to-point connections for registration and/or diagnostics. Seed monitor systems can be programmed, or configured, to display seed spacing, population and other information to the user via a cab computer of the apparatus, or other devices within the system 100. Likewise, yield monitor systems may contain yield sensors for harvester apparatus that send yield measurement data to a cab computer of the apparatus, or other devices within the system 100. Yield monitor systems may utilize one or more remote sensors to obtain grain moisture measurements in a combine, or other harvester, and transmit these measurements to the user 104 via the cab computer, or other devices within the system 100.

In an embodiment, examples of sensors that may be used with any moving vehicle, or apparatus of the type described elsewhere herein, include kinematic sensors and position sensors. Kinematic sensors may comprise any of speed sensors, such as radar or wheel speed sensors, accelerometers, or gyros. Position sensors may comprise GPS receivers or transceivers, or WiFi-based position or mapping apps that are programmed to determine location based upon nearby WiFi hotspots, among others.

In an embodiment, examples of sensors that may be used with tractors, or other moving vehicles, include engine speed sensors, fuel consumption sensors, area counters or distance counters that interact with GPS or radar signals, PTO (power take-off) speed sensors, tractor hydraulics sensors configured to detect hydraulics parameters, such as pressure or flow, and/or and hydraulic pump speed, wheel speed sensors or wheel slippage sensors. In an embodiment, examples of controllers that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors that may be used with seed planting equipment, such as planters, drills, or air seeders include seed sensors, which may be optical, electromagnetic, or impact sensors; downforce sensors, such as load pins, load cells, pressure sensors; soil property sensors, such as reflectivity sensors, moisture sensors, electrical conductivity sensors, optical residue sensors, or temperature sensors; component operating criteria sensors, such as planting depth sensors, downforce cylinder pressure sensors, seed disc speed sensors, seed drive motor encoders, seed conveyor system speed sensors, or vacuum level sensors; or pesticide application sensors, such as optical or other electromagnetic sensors, or impact sensors. In an embodiment, examples of controllers that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors that may be used with tillage equipment include position sensors for tools, such as shanks or discs; tool position sensors for such tools that are configured to detect depth, gang angle, or lateral spacing; downforce sensors; or draft force sensors. In an embodiment, examples of controllers that may be used with tillage equipment include downforce controllers or tool position controllers, such as controllers configured to control tool depth, gang angle, or lateral spacing.

In an embodiment, examples of sensors that may be used in relation to apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors, such as accelerometers disposed on sprayer booms. In an embodiment, examples of controllers that may be used with such apparatus include pump speed controllers; valve controllers that are programmed to control pressure, flow, direction, PWM and the like; or position actuators, such as for boom height, subsoiler depth, or boom position.

In an embodiment, examples of sensors that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors, such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers that may be used with harvesters include header operating criteria controllers for elements, such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors that may be used with grain carts include weight sensors, or sensors for auger position, operation, or speed. In an embodiment, examples of controllers that may be used with grain carts include controllers for auger position, operation, or speed.

In an embodiment, examples of sensors and controllers may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage and configure any of the foregoing sensors.

According to one embodiment, the techniques described herein are implemented by one or more special-purpose computing devices. The special-purpose computing devices may be hard-wired to perform the techniques, or may include digital electronic devices, such as one or more application-specific integrated circuits (ASICs) or field programmable gate arrays (FPGAs), that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 7 is a block diagram that illustrates a computer system 700 upon which embodiments of the present disclosure may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708, or other static storage device coupled to bus 702, for storing static information and instructions for processor 704. A storage device 710, such as a magnetic disk, optical disk, or solid-state drive, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x, etc.) and a second axis (e.g., y, etc.), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of, or in combination with, software instructions.

The term “storage media” as used herein refers to any non-transitory media that stores data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from, but may be used in conjunction with, transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infrared data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infrared signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) for each of multiple treatment trials in agricultural fields, generating, by a computing device, a post-harvest trial block, based on multiple data layers associated with the agricultural field, the post-harvest trial block defining an area of the agricultural field associated with the treatment trial; (b) clustering, by a computing device, a training set of the post-harvest trial block based on one or more geospatial features of the areas of the post-harvest trial blocks; (c) training, by the computing device, a model to indicate a label for a target post-harvest trial block based on the one or more geospatial features of an area of the target post-harvest trial block; and/or (d) storing the label in a memory.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in assessing treatment trials associated with agricultural fields, the method comprising:
for each of multiple treatment trials in agricultural fields, generating, by a computing device, a post-harvest trial block, based on multiple data layers associated with the agricultural field, the post-harvest trial block defining an area of the agricultural field associated with the treatment trial;
clustering, by a computing device, a training set of the post-harvest trial block based on one or more geospatial features of the areas of the post-harvest trial blocks;
training, by the computing device, a model to indicate a label for a target post-harvest trial block based on the one or more geospatial features of an area of the target post-harvest trial block; and
storing the label in a memory.

2. The computer-implemented method of claim 1, further comprising assigning labels to the training set of the post-harvest trial blocks, prior to clustering the training set of post-harvest trial blocks.

3. The computer-implemented method of claim 1, wherein the multiple data layers include a headlands layer, an emergent data layer, a split planting data layer, and a planting traversals data layer; and
wherein the method further comprises combining the headlands data layer, the emergent data layer, the split planting data layer, and the planting traversals data layer into a post-planting trial block and then combining the post-planting trial block and a confounded data later into the post-harvest trial block.

4. The computer-implemented method of claim 1, wherein clustering the training set of post-harvest trial blocks includes clustering, by a K-mean clustering algorithm, the training set of post-harvest trial blocks.

5. The computer-implemented method of claim 1, wherein the model includes a classifier model and wherein training the model includes:
training a classifier model with the training set of post-harvest trial blocks;
appending labels to a portion of unlabeled post-harvest trial blocks;
assessing a confidence of each appended label to the portion of the unlabeled post-harvest trial blocks; and
based on the confidence, adding the unlabeled post-harvest trial blocks with the appended labels to the training set and retaining the classifier model.

6. The computer-implemented method of claim 1, wherein training the model includes:
clustering the training set of post-harvest trial blocks and a plurality of unlabeled post-harvest trial blocks; and
appending labels to the unlabeled post-harvest trial blocks; and
training the model based on the training set and the label post-harvest trial blocks.

7. The computer-implemented method of claim 6, wherein clustering the training set of post-harvest trial blocks and the plurality of unlabeled post-harvest trial blocks includes clustering, by a K-mean clustering algorithm, the training set of post-harvest trial blocks and the plurality of unlabeled post-harvest trial blocks.

8. The computer-implemented method of claim 1, wherein the treatment trial is defined by the planting of two different hybrid seeds.

9. A non-transitory computer-readable storage medium including executable instructions, which, when executed by at least one processor, cause the at least one processor to:
for each of multiple treatment trials in agricultural fields, generate a post-harvest trial block, based on multiple data layers associated with the agricultural field, the post-harvest trial block defining an area of the agricultural field associated with the treatment trial;
cluster a training set of the post-harvest trial block based on one or more geospatial features of the areas of the post-harvest trial blocks;
train a model to indicate a label for a target post-harvest trial block based on the one or more geospatial features of an area of the target post-harvest trial block; and
store the label in a memory in communication with the at least one processor.

10. The non-transitory computer-readable storage medium of claim 9, wherein the executable instructions, when executed by the at least one processor, further cause the at least one processor to assign labels to the training set of the post-harvest trial blocks, prior to clustering the training set of post-harvest trial blocks.

11. The non-transitory computer-readable storage medium of claim 10, wherein the multiple data layers include a headlands layer, an emergent data layer, a split planting data layer, and a planting traversals data layer; and
wherein the executable instructions, when executed by the at least one processor, further cause the at least one processor to combine the headlands data layer, the emergent data layer, the split planting data layer, and the planting traversals data layer into a post-planting trial block and then combine the post-planting trial block and a confounded data later into the post-harvest trial block.

12. The non-transitory computer-readable storage medium of claim 11, wherein the executable instructions, when executed by the at least one processor to cluster the training set of post-harvest trial blocks, cause the at least one processor to cluster the training set of post-harvest trial blocks by a K-mean clustering algorithm.

13. The non-transitory computer-readable storage medium of claim 9, wherein the model includes a classifier model; and
wherein the executable instructions, when executed by the at least one processor to train the model, cause the at least one processor to:
train the classifier model with the training set of post-harvest trial blocks;
append labels to a portion of unlabeled post-harvest trial blocks;
assess a confidence of each appended label to the portion of the unlabeled post-harvest trial blocks; and
based on the confidence, add the unlabeled post-harvest trial blocks with the appended labels to the training set and retaining the classifier model.

14. The non-transitory computer-readable storage medium of claim 9, wherein the executable instructions, when executed by the at least one processor to train the model, cause the at least one processor to:
cluster the training set of post-harvest trial blocks and a plurality of unlabeled post-harvest trial blocks; and
append labels to the unlabeled post-harvest trial blocks; and
train the model based on the training set and the label post-harvest trial blocks.

15. The non-transitory computer-readable storage medium of claim 14, wherein the executable instructions, when executed by the at least one processor cluster the training set of post-harvest trial blocks and the plurality of unlabeled post-harvest trial blocks, cause the at least one processor to cluster the training set of post-harvest trial blocks and the plurality of unlabeled post-harvest trial blocks by a K-mean clustering algorithm.

16. The non-transitory computer-readable storage medium of claim 9, wherein the treatment trial is defined by the planting of two different hybrid seeds.

17. A system for use in assessing treatment trials associated with agricultural fields, the system comprising at least one computing device configured to:
for each of multiple treatment trials in agricultural fields, generate a post-harvest trial block, based on multiple data layers associated with the agricultural field, the post-harvest trial block defining an area of the agricultural field associated with the treatment trial;
cluster a training set of the post-harvest trial block based on one or more geospatial features of the areas of the post-harvest trial blocks;
train a model to indicate a label for a target post-harvest trial block based on the one or more geospatial features of an area of the target post-harvest trial block; and
store the label in a memory associated with the at least one computing device.

18. The system of claim 17, wherein the at least one computing device is further configured to assign labels to the training set of the post-harvest trial blocks, prior to clustering the training set of post-harvest trial blocks.

19. The system of claim 17, wherein the multiple data layers include a headlands layer, an emergent data layer, a split planting data layer, and a planting traversals data layer; and
wherein the at least one computing device is further configured to combine the headlands data layer, the emergent data layer, the split planting data layer, and the planting traversals data layer into a post-planting trial block and then combining the post-planting trial block and a confounded data later into the post-harvest trial block.

20. The system of claim 17, wherein the model includes a classifier model; and
wherein the at least one computing device is configured, in order to train the model, to:
train a classifier model with the training set of post-harvest trial blocks;
append labels to a portion of unlabeled post-harvest trial blocks;
assess a confidence of each appended label to the portion of the unlabeled post-harvest trial blocks; and
based on the confidence, add the unlabeled post-harvest trial blocks with the appended labels to the training set and retaining the classifier model.
